(19) United States
(12) Patent Application Publication
(10) Pub. No.: US 2022/0033172 A1
(43) Pub. Date: Feb. 3, 2022

(54) CAPSULE FOR BEVERAGE MACHINE AND INJECTOR HEAD THEREOF

(71) Applicant: Eric Favre, ST-BARTHELEMY (CH)

(72) Inventor: Eric Favre, ST-BARTHELEMY (CH)

(21) Appl. No.: 17/278,999

(22) PCT Filed: Sep. 25, 2019
(86) PCT No.: PCT/EP2019/075949

§ 371 Date: Mar. 23, 2021

(30) Foreign Application Priority Data
Sep. 27, 2018 (EP) 18197319.9

(51) Int. Cl. B65D 85/804; A47J 31/40

(52) U.S. Cl. CPC B65D 85/8067; A47J 31/407

(57) ABSTRACT

The invention relates to a capsule including a capsule housing and beverage ingredients contained in a hermetic chamber of the capsule housing for preparing a beverage. The capsule housing comprises a top wall, a lateral wall and a bottom wall, said walls surrounding the hermetic chamber. The hermetic chamber comprises a lower chamber section adjacent the bottom wall and an upper chamber section adjacent the top wall. The beverage ingredients comprises at least one primary beverage component contained in the lower chamber section and at least one secondary beverage component contained in the upper chamber section. The top wall of the capsule housing is configured to be perforated or sectioned by an injector head of a beverage machine and the bottom wall is configured to be perforated or sectioned by an extractor device for preparing a drink by injecting water into the upper chamber section of the capsule housing and extracting the beverage through the bottom wall.

### FIELD OF THE INVENTION

The present invention relates to a capsule and an injector head of beverage machine for preparing hot drinks, particularly tea, tisane, coffee and chocolate drinks.

### BACKGROUND OF THE INVENTION

Beverage machines using conical frustum-shaped capsules for preparing hot drinks are well known. There are in general two ways for extracting the content of these capsules which are adapted accordingly. One way consists in injecting water through the smaller of two opposite sides of the capsule while the preparation exits through the larger of these two opposite sides. The other way consists in injecting water inversely, i.e. injecting water through the larger side and the preparation exists through the opposite smaller side of the capsule. Beverages which appeal to the consumers are a subtle and precise combination of different components which are often not compatible to be stored and conserved together in a capsule. Capsules such as the one disclosed in WO2007054479 may be divided into at least first and second separated compartments. Each compartment contains an ingredient or a mixture of ingredients. The first compartment is arranged to release the ingredient or mixture of ingredients at a delayed time relative to the second compartment when water is introduced into the capsule to prepare the beverage. This capsule is however essentially configured to comprise a first compartment with milk or cream in different forms and a second compartment with coffee ingredients for the preparation of different types of coffee-based beverages such as a cappuccino or a latte macchiato.

### SUMMARY OF THE INVENTION

It is an object of this invention to provide a capsule for preparing beverages with different flavors that is simple and convenient to use, has a good shelf life, yet has a low impact on the environment.

It is a particular object of this invention to provide a capsule for preparing hot beverages, in particular tea or coffee, with different flavors, that is simple and convenient to use, has a good shelf life, yet has a low impact on the environment.

Another object of the invention is to provide an injector head of a beverage machine for the aforementioned capsules.

Objects of this invention have been achieved by providing a capsule according to claim 1.

Objects of this invention have been achieved by providing a capsule according to claim 2.

Objects of this invention have been achieved by providing an injector head of a beverage machine according to claim 12.

Objects of this invention have been achieved by providing a method for preparing a drink according to claim 16.

Disclosed herein is a capsule including a capsule housing and beverage ingredients contained in a hermetic chamber of the capsule housing for preparing a beverage. The capsule housing comprises a top wall, a lateral wall and a bottom wall, said walls surrounding the hermetic chamber. The hermetic chamber comprises a lower chamber section adjacent the bottom wall and an upper chamber section adjacent the top wall.

The beverage ingredients comprises at least one primary beverage component contained in the lower chamber section and at least one secondary beverage component contained in the upper chamber section. The top wall of the capsule housing is configured to be perforated or sectioned by an injector head of a beverage machine and the bottom wall is configured to be perforated or sectioned by an extractor device for preparing a drink by injecting water into the upper chamber section of the capsule housing and extracting the beverage through the bottom wall.

According to an aspect of the invention, the at least one primary beverage component is ground coffee or tea leaves, while the at least secondary beverage component is a flavor substance.

According to an aspect of the invention, the at least one primary beverage component is a plant substance while the at least secondary beverage component is a medicinal substance. The plant substance includes any one or more or leaves, roots, barks, fruits, seeds or stems of a plant, for instance in a dried and chopped, broken or ground form. The medicinal substance may for instance comprise a medicinal plant or an extract thereof, or a pharmaceutical compound, for instance in a liquid, gel or powder form. In the case of medicinal plants, the medicinal substance may include any one or more or leaves, roots, barks, fruits, seeds or stems of said medicinal plant, for instance in a dried and chopped, broken or ground form. An extract of the medicinal plant may be in a dry powder, gel, or liquid form.

According to another aspect of the invention, the one or more compartments of the upper chamber section is/are formed, at least partially, but preferably entirely, by edible water soluble walls forming a shell within which a said beverage substance is contained.

In an advantageous embodiment, a primary component of these water soluble shells is derived from tapioca, preferably naturally fermented into pullulan.

In an embodiment, the upper chamber section comprises a plurality of flavor substances, whereby each compartment contains one of said plurality of flavor substances.

In an embodiment, the upper chamber section comprises a plurality of compartments. The compartments are formed by said shells that form together a conical frustum-shape that fills the upper chamber section.

Each compartment may be entirely surrounded by walls of a shell such that each shell completely encapsulates a beverage substance contained within the shell.

The shells encapsulating different beverage substances may have different thicknesses, humidity, or composition configured to dissolve fully over different lengths of time in order to have a delayed release of beverage substances as a function of the type of substance.

In a variant, the flavor substance or each flavor substance is in the form of a gel or solid substance that is soluble.

In an embodiment, the gel or solid substance forms a conical frustum-shaped body that fills the upper chamber section.

The several secondary beverage components may in embodiments be flavor substances, or additional beverage substances such as powdered milk or a sweetener such as sugar.

In an embodiment, the at least one primary beverage component is tea, coffee, tisane or chocolate.

In an embodiment, said shells or soluble gels or soluble solid of different substances are arranged to form sectors or concentric rings within the upper chamber section.

Further disclosed herein, according to another aspect of the invention, is an injector head of a beverage machine for preparing a drink, configured to perforate or section the capsule housing top wall of the capsule described above. The injector head comprises a support body and an injector connected to the support body. The injector comprises a conduit, an injector inlet for injecting water into the conduit and an injecting portion for injecting water into the upper chamber section of the capsule housing.

The internal profile of the conduit may advantageously be configured to produce rotating or whirling flow of water.

In an embodiment, the conduit comprises a helical passage.

In an embodiment, the helical thread gradient of the helical passage decreases towards the injection portion.

In an embodiment, the injection portion comprises primary injector outlets configured for injecting water directly into the upper chamber section of the capsule housing, and secondary injector outlets for injecting water above the top wall of the capsule housing.

In an embodiment, the injector head further comprises a central perforating element. The locations of the primary injector outlets are located closer than the secondary injector outlets in relation to the distal end of the central perforating element.

In an embodiment, the injector head further comprises radial perforating elements arranged on a mounting surface around the central perforating element.

In an embodiment, the injector head further comprises a sealing ring mounted on the support body and configured to be brought against an annular portion of the top wall of the capsule housing. The annular portion is supported by a circular rim extending outwardly from the upper edge of the lateral wall of said capsule housing, thereby resisting to the pressure applied by the sealing ring to create an upper chamber section that is sealed from the outside environment when the top wall of the capsule housing has been sectioned or perforated by the injector head.

Also disclosed herein, according to another aspect of the invention, is a beverage machine for preparing a drink comprising the injector head as described above.

Yet further disclosed herein, according to another aspect of the invention, is a method for preparing a drink comprising: providing the capsule and the injector head as described above; moving the injector head so as to perforate or section the central portion of the top wall of the capsule housing and to bring the sealing ring of the injector head against an annular portion of the top wall in order to seal the upper chamber section from the outside environment; and injecting water into the upper chamber section of the capsule housing in order to mix water with the at least one secondary beverage component within the upper chamber section and to extract or drain the diluted secondary beverage component from the upper chamber section into the lower chamber section of the capsule housing containing the at least one primary component.

In an embodiment, the upper chamber section of the capsule housing comprises a plurality of secondary beverage components. The secondary beverage components are mixed together and extracted or drained from the upper chamber section into the lower chamber section of the capsule housing.

In an embodiment, additional portions of the top wall of the capsule housing are perforated or sectioned around the central portion of said top wall. The water is injected above the perforated or sectioned top wall, thereby flowing into these perforated or sectioned additional portions and deflecting concavely said top wall of the capsule housing.

The water soluble edible shell is dissolved by the water injected into the capsule during the beverage preparation process.

Advantageously, the water soluble shells or gel bodies for the beverage components provides on the one had a good separation of substances prior to preparing a beverage that ensures good conservation of substances and optimal flavor, in a very ecological manner. In addition, the ability to individually prepare the shells or bodies prior to insertion in the hermetic capsule confers great flexibility in the manufacturing of capsules with different flavors while maintaining a standard assembly procedure comprising inserting the flavor compartments in the capsules.

### BRIEF DESCRIPTION OF THE DRAWINGS

Further objects and advantageous aspects of the invention will be apparent from the claims, and from the following detailed description and accompanying figures.

FIG. 1 is a perspective view of a capsule according to the invention;

FIG. 2 is a perspective view of the capsule of FIG. 1 without the top wall and without a portion of the lateral wall according to an embodiment of the invention;

FIG. 3 is a top view of FIG. 1;

FIG. 4 is a cross-sectional view of FIG. 3 taken along the line A-A;

FIG. 5 is an exploded view of the capsule of FIG. 1;

FIG. 6 is a perspective view of both the capsule and the injector head, with a partial view of the inner side of the capsule of FIG. 1;

FIG. 7 is a front view of both the capsule and the injector head which is perforating the capsule;

FIG. 8 is an exploded view of the injector head of FIG. 7,

FIG. 9 is a bottom perspective view of the injector head of FIG. 7;

FIG. 10 is a diametrical cross-sectional view of the injector head of FIG. 9;

FIG. 11 is a diametrical cross-sectional view of the capsule and the injector head in an operating position for water injection.

### DETAILED DESCRIPTION OF EMBODIMENTS OF THE INVENTION

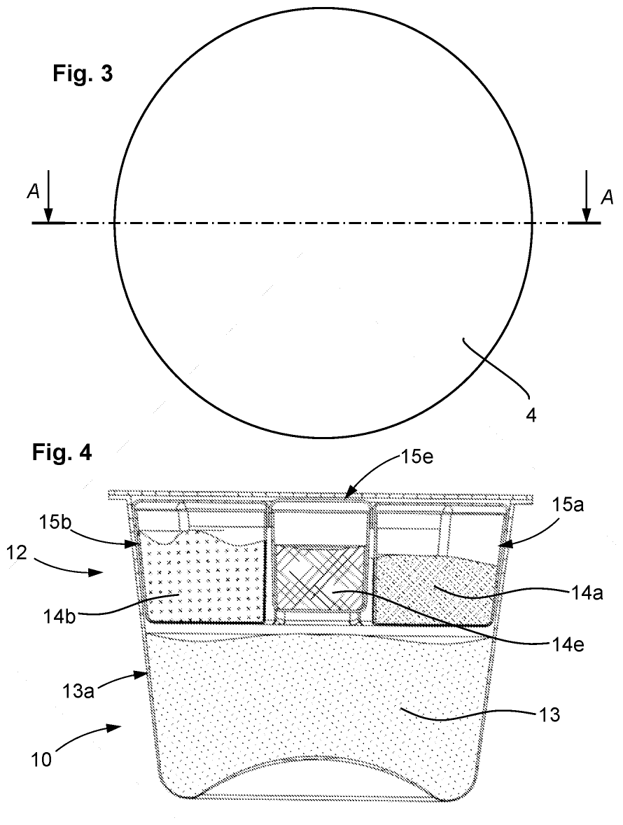

Referring to the figures, in particular FIGS. 1 to 5, a capsule 2 comprises a capsule housing 3 and beverage ingredients 13, 14a, 14b, 14c, 14d, 14e contained in a hermetic chamber of the capsule housing 3 for preparing a hot beverage. The capsule housing 3 comprises a top wall 4, a lateral wall 6, a bottom wall 8 and a circular rim 7 extending outwardly from the upper edge of the lateral wall 6 and against which an annular portion of the top wall 4 of the capsule housing 3 is bound. The capsule housing 3 comprises a lower chamber section 10 adjacent the bottom wall 8 and an upper chamber section 12 adjacent the top wall 4 of the capsule housing 3. Each of the lower and upper chamber sections 10, 12 has preferably a conical frustum-shape. The lower chamber section 10 contains a primary beverage component 13, which may be for example coffee, tisane, tea, chocolate or any other vegetal substance.

The primary beverage component 13 may be for example a ground substance such as ground coffee, or dried plant components such as dried tea leaves or dried herbs, or a lyophilized or freeze-dried substance such as powdered milk or granulated coffee. The dried plant components may consist of or include one or more medicinal plants.

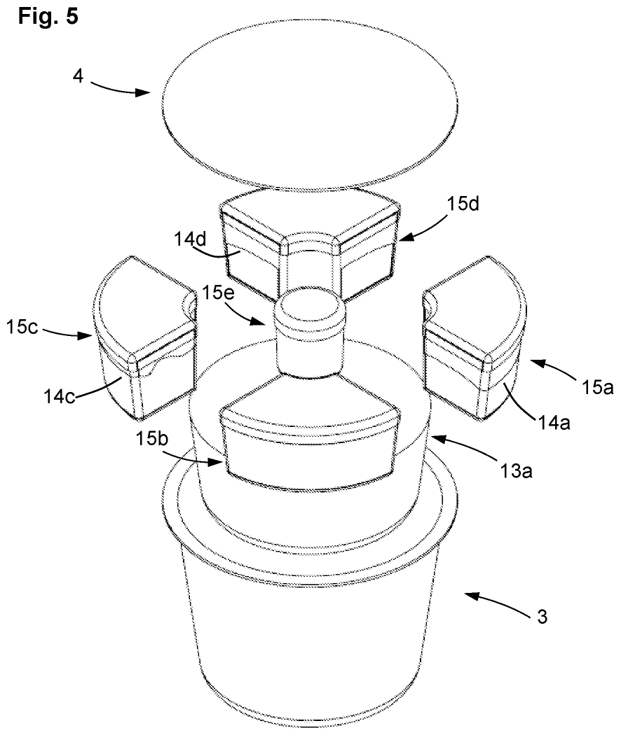

The upper chamber section 12 contains one or more secondary beverage components to be mixed with the primary beverage component. In an advantageous embodiment illustrated in FIG. 5, the upper chamber section 12 of the capsule comprises different compartments in the form of edible water soluble shells 15a, 15b, 15c, 15d, 15e.

In a particular embodiment, the secondary beverage component may also consist of or include medicinal plants or medicinal or pharmaceutical products.

Each shell may contain one or more flavor substances such as a flavor extract that can be chemically or naturally produced, and dissolved in water, to bring to the drink the desired aromas.

In a particular embodiment, each shell may contain one or more medicinal or pharmaceutical substances are soluble in water, to bring to the drink medicinal substances. The shells may have different thicknesses or moisture levels such that the time of dissolution is different from one shell to another in order to have a delayed release of the medicinal or pharmaceutical substances. Different shells may dissolve fully at different times such that different medicinal substances are released at different times. This may be particularly advantageous for the preparation of a medicinal beverage with a plurality of medicinal substances where the order of assembly and mixing of the substances is of importance for the characteristics of the final beverage.

The temperature of the injected water may also be varied and set at an optimal temperature for the beverage substances. For instance, certain beverage components may have optimum infusion temperatures below boiling point, for instance in a range from 75° C. to 90° C. A delayed infusion of certain substances may also be used to vary both the time of infusion and the temperature, whereby a delayed infusion due to a shell that has a long dissolution time also affects the temperature of infusion which decreases over time.

An example of a medicinal beverage is for instance a Guihzhi decoction well known in Chinese medicine. Many other plant based medicinal beverages based on Chinese customs may advantageously benefit from extraction in a beverage system according to the present invention.

In an embodiment, the shells may advantageously be made from tapioca naturally fermented into pullulan. Other water soluble edible substances for the shell containers may however be used within the scope of this invention, for instance from various starches obtained from rice, maize, wheat or extracts of other grains. Edible water soluble gel or jelly substances, for instance extracted from bone or cartilage, may also be used as sole or principle components of the shell material.

The use of tapioca for the shells is advantageously free of starch, gluten and preservatives, and moreover has a neutral taste that does not affect the flavor of the beverage.

The shells may be arranged according to different configurations. The shells may form closed containers, each completely surrounding the compartment in which the corresponding beverage substance is contained. The upper chamber section 12 may comprise for example four sector-shaped shells 15a, 15b, 15c, 15d and optionally a circular-shaped shell 15e in the middle of the upper chamber section 12. The shells form together a conical frustum-shaped clump that fills the upper chamber section 12. In an embodiment, the circular edge of this body may be bound to the inner surface of the lateral wall 6 of the capsule housing 3 for example with an edible sugar-based adhesive.

In an embodiment, the one or more secondary beverage components may be for example in the form of soluble jellified substance or soluble solid substance that release their flavor or medicinal ingredient when dissolved in water and mixed with the primary beverage component.

In another non-illustrated embodiment, the shells or the jellified or solid substances may be in the form of concentric rings contained in the upper chamber section. In another non-illustrated embodiment, the upper chamber section may comprise separators defining several compartments comprising each a flavor extract or medicinal extract in liquid form.

The separators may be permanent, or dissolvable in water above a predetermined temperature, depending on the embodiment.

Permanent separators may be made of filter paper configured to hold the different substances in their respective compartment to prevent mixing prior to water injection for beverage preparation, while being at the same time permeable for flavor transfer or possible gas transfer between the compartments. The filter paper may be partially impermeable by means of deposit of gel or other substances having different degrees of permeability. The separators may be made from tapioca which is naturally fermented into pullulan.

A porous wall may be mounted between the lower and upper chamber sections.

In an embodiment, the primary component 13 fills entirely the lower chamber section 10 of the capsule housing 3 and may be encapsulated in an shell 13a (FIG. 5) preferably made from tapioca naturally fermented into pullulan. A disk-shaped gap 15 is provided in the capsule housing between the lower and upper chamber sections 10, 12.

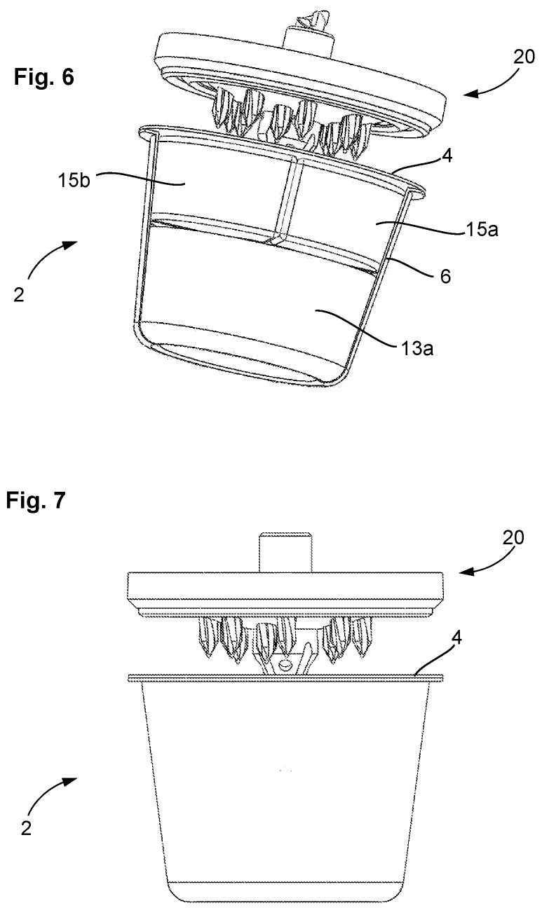

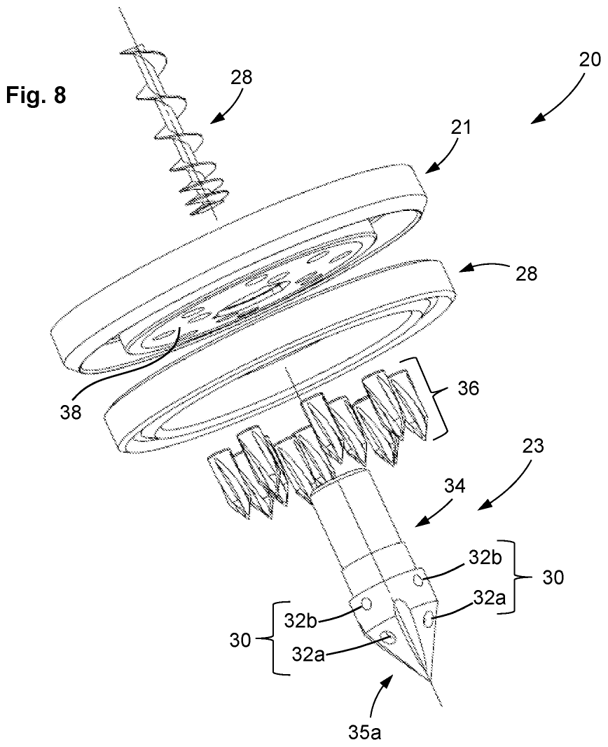

In an embodiment as illustrated by FIGS. 6-12, the top wall 4 of the capsule housing 3 is configured to be perforated or sectioned by an injector head 20 of a beverage machine (not shown). The injector head 20 is configured to inject water into the upper chamber section 12 of the capsule housing 3 in order to drain the favor extracts contained in the shells or in the jellified or solid substances into the lower chamber section 10 of the capsule housing 3. As particularly shown in FIGS. 8-10, the injector head 20 comprises a support body 21 and an injector 23 mounted through the support body 21 along the central axis thereof. The injector 23 comprises a conduit 26, an injector inlet 24 for injecting water into the conduit 26 and an injecting portion 30 for injecting water into the upper chamber section 12 of the capsule housing 3.

The inner surface or the internal shape of the conduit 26 may have different configurations to produce rotating flow for improved mixing of the secondary components within the upper chamber section 12. For example, the conduit 26 may comprise a helical element 28 to create a helical passage 29 with an helical step that decreases towards the injection portion 30 so as to accelerate the speed of the water flow along the conduit and to inject a rotating flow of water into the upper chamber section 12 in order to create a vortex within the chamber section 12 for optimum mixing of the different secondary components. A central perforating element 34 is mounted at the distal end of the conduit 26 and comprises the injection portion 30 that includes primary injector outlets 32a configured for injecting water directly into the upper chamber section 12 of the capsule housing 3, and secondary injector outlets 32b for injecting water above the top wall 4 of the capsule housing 3.

The central perforating element 34 comprises a hallow conical-shaped portion 35a with an apex angle that may vary between 10° and 30° and a ring-shaped base portion 35b in fluid communication with interior of the conical-shaped portion 35a and with the conduit 26 of the injector 23.

The primary injector outlets 32a are located on the surface of the conical-shaped portion 35a of the central perforating element 34 and form channels across the conical-shaped portion side walls. The channels are oriented along an axis that forms an angle preferably between 20° and 90° with respect to the longitudinal axis of the central perforating element 34. These channels may have preferably a conical-shaped profile to increase the speed of the water flow. The number of secondary injector outlets 32b may vary preferably between two and ten and are distributed around the ring-shaped base portion 35b of the central perforating element 34. These secondary injector outlets 32b form channels across the ringed-shaped portion 35b along an axis that may be for example perpendicular to the longitudinal axis of the central perforating element 34.

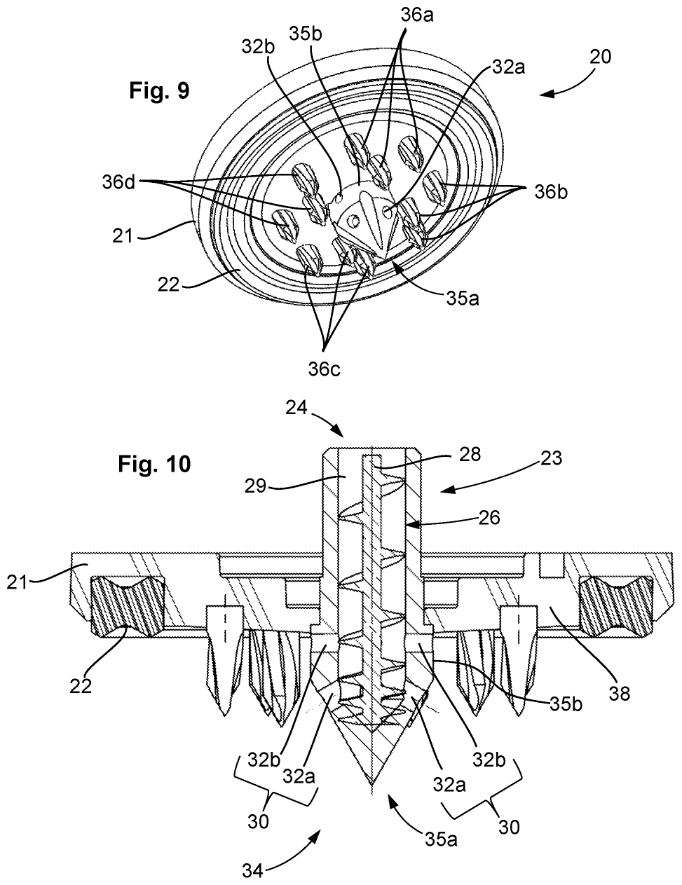

The injector head 20 further comprises radial perforating elements 36a, 36b, 36c, 36d arranged on a mounting surface 38 around the conical-shaped perforating element 34. In an embodiment, as shown in FIG. 9, the injector head 20 comprises four sets of three radial perforating elements 36a, 36b, 36c, 36d. Each of these sets of radial perforating elements is configured to perforate or section a portion of the top wall 4 of the capsule housing and the corresponding sector-shaped shells 15a, 15b, 15c, 15d or jellified or solid substances contained in the upper chamber section 12.

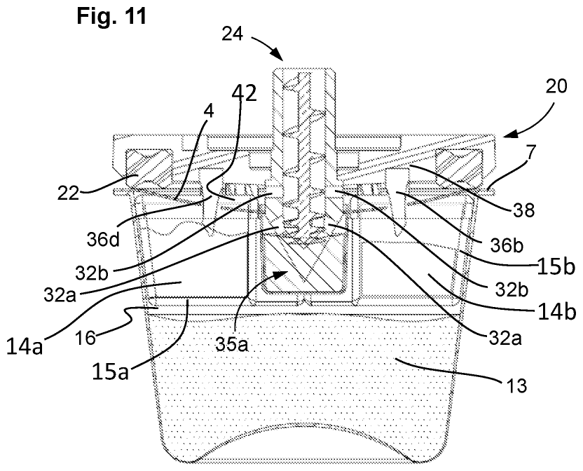

A sealing ring 22 is mounted on a circular groove arranged around the mounting surface 38 and near the circular edge of the support body 21. As shown in FIGS. 11 and 12, a portion of the sealing ring 22 is brought against an annular portion of the top wall 4. This annular portion is supported by the circular rim 7 of the lateral wall upper edge of the capsule housing 3 so as to resist to a pressure exerted by the sealing ring 22 that is sufficient for sealing the upper chamber section 12 from the outside environment when the injector head 20 has perforated or sectioned the top wall 4 of the capsule housing 3 and has reached an operating position, whereupon water is injected into the upper chamber section 12.

In an advantageous embodiment, primary and secondary injector outlets 32a, 32b are positioned respectively below and above the perforated or sectioned top wall 4 of the capsule housing 3 when the injector head 20 is in the operating position. As previously described, the primary injector outlets 32a, 32b are configured to inject directly into the upper chamber section 12 a rotating flow of water for diluting and mixing one or several secondary components within the upper chamber section 12. The secondary injector outlets 32b are configured to inject water into a space 42 created between the top wall 4 of the capsule housing 3 and the mounting surface 38 of the injector head 20.

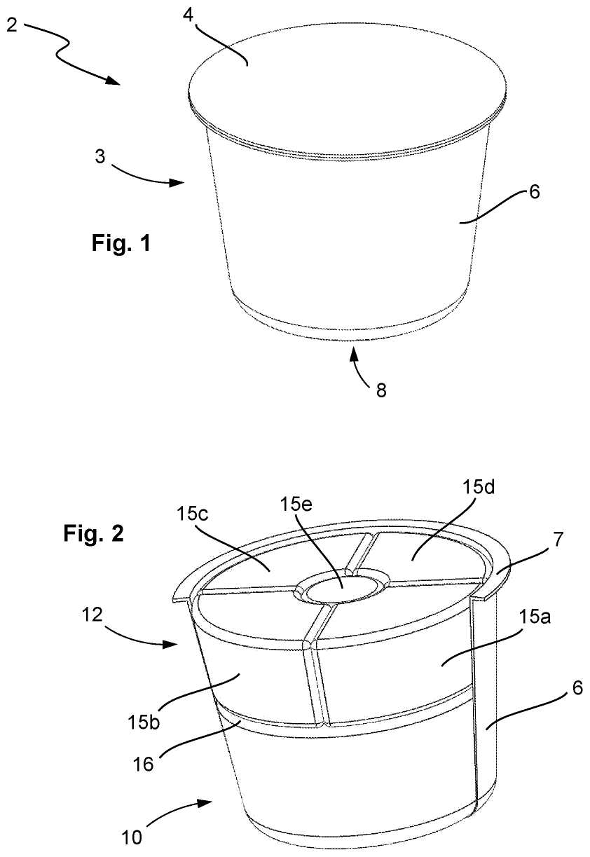

As shown in FIG. 11, the water injected in the space 42 may be in a liquid state or in a vapor state which increases the pressure within this space thereby deflecting concavely the top wall 4 and flowing water into perforated or sectioned portions of the top wall 4 above corresponding shells or soluble jellified or solid substances such as the ones shown in FIGS. 2 and 5. The top wall 4 of the capsule housing 3 may be further deflected by injecting additional water into that space so as to squeeze out the entirely content of the upper chamber section 12 into the lower chamber section 10 of the capsule housing 3.

In an embodiment, the upper chamber may comprise at least two secondary components and preferably three, four or five secondary components which comprise each a particular flavor or medicinal substance and which may selectively be drained, at the different time intervals, into the lower chamber containing the primary component. In particular, each of these components may dissolve at different temperatures. One of some of these components may be dissolved at lower temperatures than other components. These components may therefore be drained together or successively into the lower chamber section 10 at different time intervals which are dependent on the temperature within the upper chamber section 12 of the capsule housing 3.

The bottom wall 8 of the capsule housing 3 is configured to be perforated or sectioned by an extractor device (not shown) of a beverage machine for preparing a drink by injecting water into the upper chamber section of the capsule housing and extracting the beverage through the bottom wall 8. Extractor devices such as a perforating base are per se well known in the art and need not be described in the present.

### REFERENCE LIST

Capsule 2
   Capsule housing 3
      Top wall 4
      Lateral wall 6
         Circular rim 7
      Bottom wall 8
      Lower chamber 10 (Conical frustum shaped)
      Upper chamber 12 (Conical frustum shaped)
         Compartments (one embodiment)
            Separators
         Porous wall (one embodiment)
         Disk-shaped gap 16 (one embodiment)
   Beverage ingredients
      Primary beverage component(s) 13
         Shell 13a
         Coffee, tea, tisane, chocolate, etc.
      Secondary beverage component(s) 14a, 14b, 14c, 14d, 14e
         Shells 15a, 15b, 15c, 15d, 15e
            Sectors 15a, 15b, 15c, 15d
            Concentric rings
            Flavor substance
         Jellified substances
         Dissolvable separators
Injector head 20
   Support body 21 (disc shaped)
      Seal 22
         Sealing ring
      Injector 23
         Injector inlet 24
         Conduit 26
            Helical element 28
            Helical step decreasing towards injection outlets
            Helical passage 29
         Injecting portion 30
            Primary injector outlets 32a
            Secondary injector outlets 32b
         Central perforating element 34 (10-30°)
            Conical-shaped portion 35a
            Base portion 35b
         Radial perforating elements 36; 36a, 36b, 36c, 36d
            Mounting surface 38
Extractor device
Space 42 (between the injector head and the top wall)

1.-18. (canceled)

19. A capsule including a capsule housing and beverage ingredients contained in a hermetic chamber of the capsule housing for preparing a beverage, the capsule housing comprising a top wall, a lateral wall and a bottom wall, said walls surrounding the hermetic chamber, the hermetic chamber comprising a lower chamber section adjacent the bottom wall and an upper chamber section adjacent the top wall, the beverage ingredients comprising at least one primary beverage component contained in the lower chamber section and at least one secondary beverage component contained in the upper chamber section comprising one or more compartments, the top wall of the capsule housing configured to be perforated or sectioned by an injector head of a beverage machine and the bottom wall configured to be perforated or sectioned for preparing a drink by injecting water into the upper chamber section of the capsule housing and extracting the beverage through the bottom wall, wherein the one or more compartments of the upper chamber section is/are formed at least partially by edible water soluble walls.

20. A capsule including a capsule housing and beverage ingredients contained in a hermetic chamber of the capsule housing for preparing a beverage, the capsule housing comprising a top wall, a lateral wall and a bottom wall, said walls surrounding the hermetic chamber, the hermetic chamber comprising a lower chamber section adjacent the bottom wall and an upper chamber section adjacent the top wall, the beverage ingredients comprising at least one primary beverage component contained in the lower chamber section and at least one secondary beverage component contained in the upper chamber section comprising one or more compartments, the top wall of the capsule housing configured to be perforated or sectioned by an injector head of a beverage machine and the bottom wall configured to be perforated or sectioned for preparing a drink by injecting water into the upper chamber section of the capsule housing and extracting the beverage through the bottom wall, wherein the at least one primary beverage component is a plant substance, while the at least secondary beverage component is a flavor substance.

21. The capsule according to claim 20, wherein the one or more compartments of the upper chamber section is/are formed at least partially by edible water soluble walls.

22. The capsule according to claim 19, wherein the at least one primary beverage component is a plant substance.

23. The capsule according to claim 19, wherein the at least one secondary beverage component is a medicinal substance.

24. The capsule according to claim 20, wherein the plant substance is any one of tea, coffee, tisane or chocolate.

25. The capsule according to claim 19, wherein a principle component of the edible water soluble walls is derived from tapioca.

26. The capsule according to claim 19, wherein the upper chamber section comprises a plurality of compartments.

27. The capsule according to claim 26, wherein said compartments form together a conical frustum-shaped assembly that fills the upper chamber section.

28. The capsule according to claim 19, wherein the one or more compartments of the upper chamber section are encapsulated by walls of said edible water soluble substance.

29. The capsule according to claim 28, wherein said walls have different thicknesses or compositions configured for a time of dissolution different from one compartment wall to another.

30. An injector head of a beverage machine for preparing a drink, configured to perforate or section the capsule housing top wall of the capsule according to claim, wherein the injector head comprises a support body and an injector connected to the support body, the injector comprising a conduit, an injector inlet for injecting water into the conduit and an injecting portion for injecting water into the upper chamber section of the capsule housing, and wherein the internal profile of the conduit is configured to produce rotating or whirling flow of water.

31. The injector head according to claim 30, wherein the conduit comprises a helical passage.

32. The injector head according to claim 31, wherein the helical step of the helical passage decreases towards the injection portion.

33. The injector head according to claim 30, wherein the injection portion comprises primary injector outlets configured for injecting water directly into the upper chamber section of the capsule housing, and secondary injector outlets (32b) for injecting water above the top wall of the capsule housing.

34. Method for preparing a beverage comprising:
providing the capsule according to claim 19 and the injector head according to claim 30;
moving the injector head so as to perforate or section the central portion of the top wall of the capsule housing and to bring the sealing ring of the injector head against an annular portion of the top wall in order to seal the upper chamber section from the outside environment; and
injecting water into the upper chamber section of the capsule housing in order to mix water with the at least one secondary beverage component within the upper chamber section and to extract or drain the diluted secondary beverage component from the upper chamber section into the lower chamber section of the capsule housing containing the at least one primary component.

35. The method according to claim 34, wherein the upper chamber section of the capsule housing comprises a plurality of secondary beverage components, the secondary beverage components being mixed together and extracted or drained from the upper chamber section into the lower chamber section of the capsule housing.

36. The method according to claim 34, wherein additional portions of the top wall of the capsule housing are perforated or sectioned around the central portion of said top wall, and wherein water is injected above the perforated or sectioned top wall, thereby flowing into these perforated or sectioned additional portions and deflecting concavely said top wall of the capsule housing.

37. Method for preparing a beverage comprising:
providing the capsule according to claim 20 and the injector head according to claim 30;
moving the injector head so as to perforate or section the central portion of the top wall of the capsule housing and to bring the sealing ring of the injector head against an annular portion of the top wall in order to seal the upper chamber section from the outside environment; and
injecting water into the upper chamber section of the capsule housing in order to mix water with the at least one secondary beverage component within the upper chamber section and to extract or drain the diluted secondary beverage component from the upper chamber section into the lower chamber section of the capsule housing containing the at least one primary component.

38. The method according to claim 37, wherein the upper chamber section of the capsule housing comprises a plurality of secondary beverage components, the secondary beverage components being mixed together and extracted or drained from the upper chamber section into the lower chamber section of the capsule housing.

39. The method according to claim 37, wherein additional portions of the top wall of the capsule housing are perforated or sectioned around the central portion of said top wall, and wherein water is injected above the perforated or sectioned top wall, thereby flowing into these perforated or sectioned additional portions and deflecting concavely said top wall of the capsule housing.

40. The capsule according to claim 22, wherein the at least one secondary beverage component is a medicinal substance.

41. The capsule according to claim 22, wherein the plant substance is any one of tea, coffee, tisane or chocolate.

42. The capsule according to claim 20, wherein a principle component of the edible water soluble walls is derived from tapioca.

43. The capsule according to claim 20, wherein the upper chamber section comprises a plurality of compartments.

44. The capsule according to claim 43, wherein said compartments form together a conical frustum-shaped assembly that fills the upper chamber section.

45. The capsule according to claim 20, wherein the one or more compartments of the upper chamber section are encapsulated by walls of said edible water soluble substance.

46. The capsule according to claim 45, wherein said walls have different thicknesses or compositions configured for a time of dissolution different from one compartment wall to another.
